(19) United States
(12) Patent Application Publication
(10) Pub. No.: US 2023/0294267 A1
(43) Pub. Date: Sep. 21, 2023

(54) Sawhorse Device

(71) Applicant: Robbie Dupin, Vine Grove, KY (US)

(72) Inventor: Robbie Dupin, Vine Grove, KY (US)

(21) Appl. No.: 18/171,482

(22) Filed: Feb. 20, 2023

Related U.S. Application Data
(60) Provisional application No. 63/320,337, filed on Mar. 16, 2022.

(51) Int. Cl. B25H 1/06; B25H 1/12; B25H 1/16; B25H 1/18; B25H 1/04

(52) U.S. Cl. CPC B25H 1/06; B25H 1/12; B25H 1/16; B25H 1/18; B25H 1/04

(57) ABSTRACT

The present invention relates generally to the field of sawhorses. More specifically, the present invention relates to a sawhorse device that is primarily comprised of a generally rectangular body further comprised of at least one leg, at least one level bubble, at least one hook, at least one battery, and at least one charging receptacle. The body of the device is preferably sturdy, yet adjustable such that it can create a stable and level working surface on areas of uneven ground. The device may also receive power from a battery or solar panel such that it can power tools that may be used for modifying boards or other objects on the device. In this manner, the device can be used on any construction site to complete the work precisely and efficiently.

### CROSS-REFERENCE TO RELATED APPLICATION

The present application claims priority to, and the benefit of, U.S. Provisional Application No. 63/320,337, which was filed on Mar. 16, 2022, and is incorporated herein by reference in its entirety.

### FIELD OF THE INVENTION

The present invention relates generally to the field of sawhorses. More specifically, the present invention relates to a sawhorse device that is primarily comprised of a generally rectangular body further comprised of at least one leg, at least one level bubble, at least one hook, at least one battery, and at least one charging receptacle. The body of the device is preferably sturdy, yet adjustable such that it can create a stable and level working surface on areas of uneven ground. The device may also receive power from a battery or solar panel such that it can power tools that may be used for modifying boards or other objects on the device. In this manner, the device can be used on any construction site to complete the work precisely and efficiently. Accordingly, the present disclosure makes specific reference thereto. Nonetheless, it is to be appreciated that aspects of the present invention are also equally applicable to other like applications, devices and methods of manufacture.

### BACKGROUND

Construction sites are often extremely busy and cluttered. Sawhorses are often used on construction sites, wherein long extension cords are commonly needed to power tools used with the sawhorse such as saws. Further, outlets are not always easily accessible on construction sites which may allow the sawhorse to be only used at specific areas of the site. Further, existing sawhorses known in the art may not be able to be used effectively on uneven ground, thus further diminishing productivity of the workers and their ability to safely work using sawhorses.

Therefore, there exists a long-felt need in the art for an improved sawhorse device. There also exists a long-felt need in the art for a sawhorse device that can provide power to any tools that are being used with the sawhorse device. Further, there exists a long-felt need in the art for a sawhorse device that can adjust such that, the device can create a sturdy and level surface on uneven ground. In addition, there exists a long-felt need in the art for a sawhorse device that is easily transportable.

The subject matter disclosed and claimed herein, in one embodiment thereof, comprises a sawhorse device. The device is primarily comprised of a generally rectangular body further comprised of at least one leg, at least one level bubble, at least one hook, at least one battery, and at least one charging receptacle. The body of the device is preferably sturdy, yet adjustable such that it can create a stable and level working surface on areas of uneven ground. The device may also receive power from a battery or solar panel such that it can power tools via the charging receptacle of the device. In this manner, the device can be used at any construction site or work area such that work can get done more precisely, efficiently, and safely.

In this manner, the sawhorse device of the present invention accomplishes all the foregoing objectives and provides an improved means of using a sawhorse on a construction site. Further, the device can provide power to any tool that is desired to be used along with the device. In addition, the device can adjust to create a sturdy surface on uneven ground as well as fold into a convenient size to allow for transportation and setup at any location within a construction site.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sawhorse device. The device is primarily comprised of a generally rectangular body further comprised of at least one leg, at least one level bubble, at least one hook, at least one battery, and at least one charging receptacle. In differing embodiments, the dimensions of the body may be of any length, width, or height. The body may also be made of a plurality of materials that may be commonly used for construction equipment. However, the body is preferably made of a metal. In addition, any surface of the body may be comprised of a plurality of indicia such as patterns, logos, emblems, images, symbols, designs, letters, words, characters, animals, advertisements, brands, etc.

The body is also comprised of a top wall, at least one side wall, a front wall, a rear wall, and a bottom surface. The top wall is further comprised of an at least one opening that allows a board to be secured to the device. The side wall is further comprised of at least one outlet, preferably in the form of an outlet or power cord, that may be used for powering tools. The front wall is further comprised of a level bubble, indicating when the body is level, and at least one hook capable of holding at least one tool, cord, or other object. The bottom surface is further comprised of a charging receptacle and a plug. The charging receptacle may receive a battery that can provide power to the charging receptacle on the side wall of the body. The plug may receive a power cord from an outlet or a solar panel.

The device is also comprised of at least one leg that may be attached to the body via at least one hinge, allowing the legs to fold up towards the body and fit into a storage bag for storage or transportation. Each leg is further comprised of a first member, a second member, a locking handle, feet, and a cross member. The first member is hollow, allowing the second member to insert inside of the first member. To adjust the length of the leg, the second member may be extended out from the first member and locked into place using the locking handle. The cross member and feet further stabilize the device. The cross-member attaches to the first member of two separate legs and the feet provide additional grip and traction on the ground surface.

Accordingly, the sawhorse device of the present invention is particularly advantageous as it provides a portable, stable worktable on a construction site. Further, the device is adjustable such that it can create a sturdy surface on uneven ground and collapse in size to be easily transported and stored. In addition, the device can provide power to any tool that is desired to be used along with the device. In this manner, the sawhorse device overcomes the limitations of existing sawhorses known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a sawhorse device of the present invention in accordance with the disclosed architecture;

FIG. 2 illustrates an enhanced perspective view of one potential embodiment of a sawhorse device of the present invention in accordance with the disclosed architecture;

FIG. 3 illustrates a bottom perspective view of one potential embodiment of a sawhorse device of the present invention in accordance with the disclosed architecture; and

FIG. 4 illustrates a perspective view of one potential embodiment of a sawhorse device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved sawhorse device. There also exists a long-felt need in the art for a sawhorse device that can provide power to any tools that are being used in unison with the sawhorse device. Further, there exists a long-felt need in the art for a sawhorse device that can adjust, such that the device can create a sturdy and level surface on uneven ground. In addition, there exists a long-felt need in the art for a sawhorse device that is easily transportable.

The present invention, in one exemplary embodiment, is comprised of a sawhorse device that can provide power to any tool used when performing tasks on the device. The device is primarily comprised of a generally rectangular body further comprised of at least one leg, at least one level bubble, at least one hook, at least one battery, and at least one charging receptacle. In differing embodiments, the body may be of any length, width, height, or any other dimension to accommodate different sizes of boards or other materials that may be cut or used with the device. The body may also be made of a plurality of materials that are commonly used for making construction equipment but is preferably made of a metal. In addition, any surface of the body may be comprised of a plurality of indicia such as patterns, logos, emblems, images, symbols, designs, letters, words, characters, animals, advertisements, brands, etc.

Further, the body is comprised of a top wall, at least one side wall, a front wall, a rear wall, and a bottom surface. The top wall is further comprised of at least one opening that allows a board to be secured to the device via at least one fastener. The side wall is further comprised of at least one outlet (preferably in the form of a power outlet or a power cable) and at least one LED. In one potential embodiment, the outlet may be a standard power outlet known in the art that allows the cord of a power-receiving device to plug into the outlet to draw power from the device. In another potential embodiment, the outlet may be in the form of a power cord that can be pulled out from the body of the device up to a certain length and plugged into a power-receiving device. The LED of the side wall may communicate to the user if the device is fully charged. If the device is fully charged, the LED may illuminate green, and when there is little to no charge, the LED may illuminate red. The front wall is further comprised of a level bubble that indicates to the user when the top wall of the body is level as well as at least one hook that can hold at least one tool, cord, or other object. The rear wall, in one potential embodiment, may also be comprised of at least one hook capable of holding at least one tool, cord, or other object.

The bottom surface of the body is further comprised of a charging receptacle and a plug. The charging receptacle is in electrical communication with the outlet, allowing the device to charge or power any power tools known in the art. The charging receptacle can receive a portable battery from which the device draws power and transfers said power to the outlet, LED, and any other electrical components of the device. The battery may be charged by a battery charger that can be plugged into any outlet. The plug may receive power from a cord that can be plugged into the device. In one potential embodiment, a solar panel may be set up next to the device that is comprised of at least one leg and a power cord that may be inserted into the plug of the bottom surface of the device to power the device. The leg of the solar panel may be able to fold or telescope into itself such that it is easily transportable and adjustable.

The device is also comprised of at least one leg that may be fixedly or removably attached to the body via an at least one hinge, allowing the leg to fold up towards the body and making the device more transportable. Once folded, the device may easily fit into a storage bag that allows for the device to be easily stored and transported. The storage bag is further comprised of an at least one compartment that may be sealed by a zipper, fastener, or other method to hold items such as tools, cords, or other items that may be needed while using the device. Each leg is further comprised of a first member, a second member, a locking handle, feet, and a cross member. The second member may insert into the first member and be locked in place using the locking handle. To adjust the length of each leg, a user may undo the locking handle, extend the second member to the desired length, giving the device a desired height, and use the locking handle to fix the length of the leg. To further stabilize the device, a cross member may connect the first member of two separate legs to one another. In addition, each leg has a foot that may be made of a different material or be textured in a way to provide more grip to the ground on which the device is being set up.

Accordingly, the sawhorse device of the present invention is particularly advantageous as it provides a portable, stable worktable on a construction site. Further, the device can provide power to any tool that is desired to be used along with the device, removing the need for long extension cords. In addition, the device may be adjusted to create a stable and level working surface as well as fold into itself such that it can be easily transported and set up at any location on a construction site. In this manner, the sawhorse device overcomes the limitations of existing sawhorses known in the art.

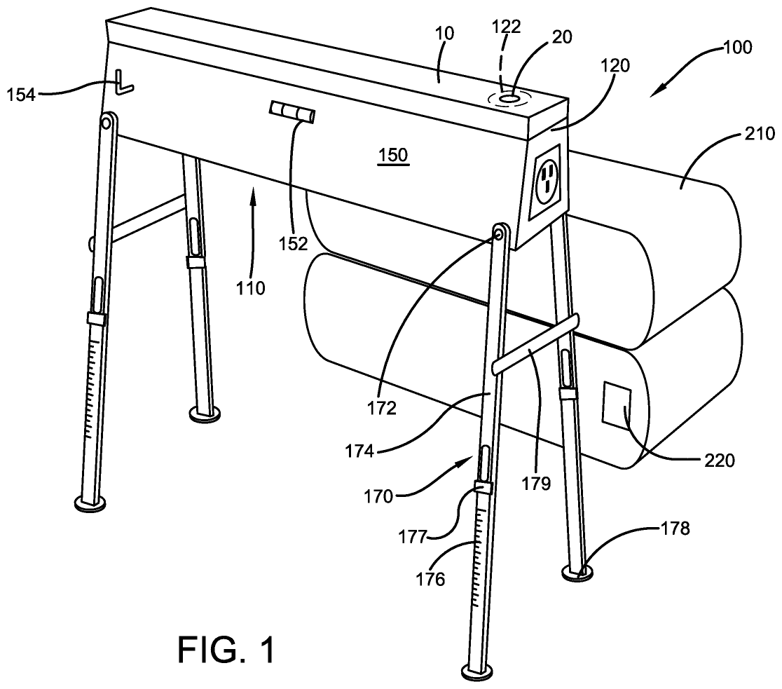

Referring initially to the drawings, FIG. 1 illustrates a perspective view of one potential embodiment of a sawhorse device 100 of the present invention in accordance with the disclosed architecture. The device 100 is primarily comprised of a generally rectangular body 110 further comprised of at least one leg 170, at least one level bubble 152, at least one hook 154, at least one battery 190, and at least one charging receptacle 132. In differing embodiments, the dimensions of the body 110 may be of any length, width, height, or other relevant dimension such that the device 100 may accommodate a board 10 or other material to be modified on the device 100. Further, the body 110 may be made of a plurality of materials such as wood or plastic but is preferably made of a metal such as, but not limited to, carbon steel, stainless steel, alloy steel, cast iron, wrought iron, aluminum, magnesium, copper, brass, bronze, zinc, titanium, tungsten, nickel, cobalt, etc. or any combination of metals in the form of an alloy. In addition, any surface of the body 110 may be comprised of a plurality of indicia such as patterns, logos, emblems, images, symbols, designs, letters, words, characters, animals, advertisements, brands, etc.

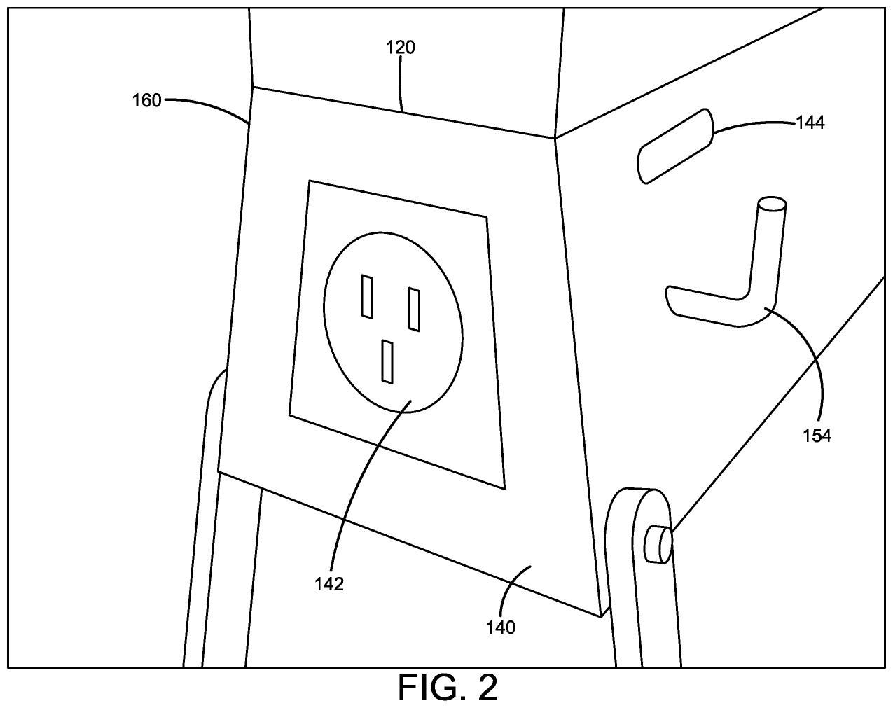

Further, the body 110 is comprised of a top wall 120, at least one side wall 140, a front wall 150, a rear wall 160, and a bottom surface 130. The top wall 120 is further comprised of at least one opening 122 that allows for a board 10 to be secured to the device 100 via at least one fastener 20 such as, but not limited to, a screw, nail, clamp, etc. In one potential embodiment, the opening 122 may be a threaded hole to allow a fastener 20, such as a screw, to secure the board 10 to the device 100. In another potential embodiment, the opening 122 may be a slot in which a board 10 may be placed and then clamped down to secure it to the device 100. Each side wall 140 and/or front wall 150 and rear wall 160 is further comprised of at least one outlet 142 and at least one LED 144 light. In one potential embodiment, the outlet 142 may a standard 110V/240V male or female power outlet known in the art that may receive the cord from a powered object (ex., a tool) to deliver power to said object (as best seen in FIG. 2). In another potential embodiment, the outlet 142 may be in the form of a power cord that is further comprised of a male or female 110V/240V outlet that can extend out and retract back into the body 110 of the device 100 up to a certain length and plugged into an object/tool to power said object/tool. The LED 144 of the side wall may illuminate green to indicate the device 100 is fully charged and all outlets 142 are receiving full power. The LED 144 may also illuminate red to indicate the device 100 is at or near zero charge. The front wall 150 is further comprised of at least one level bubble 152 to indicate when the top wall 120 of the body 110 is level on a surface and at least one hook 154 that can be used to hold tools, cords, or other objects when not in use. The rear wall 160 may also be comprised of at least one hook 154 and/or level bubble 152 for additional storage or organization of tools, cords, or other objects.

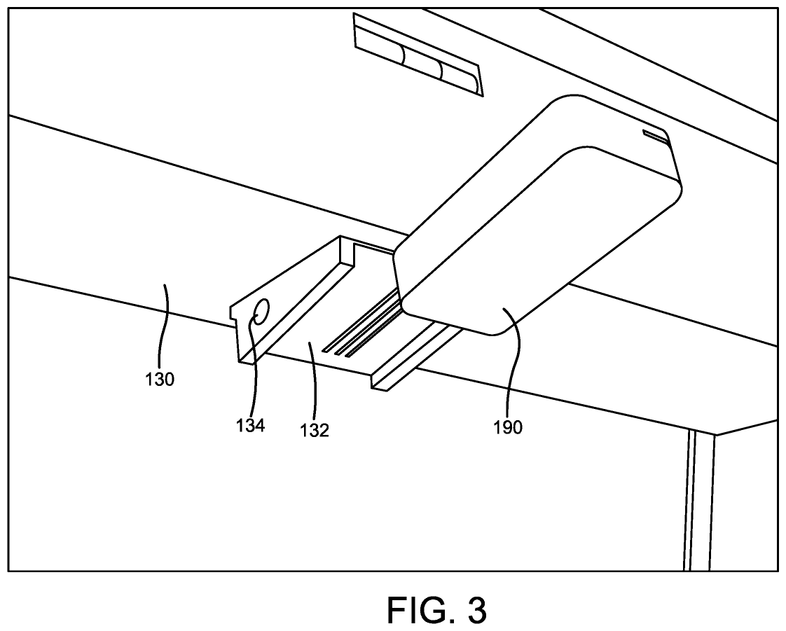

FIG. 3 illustrates a bottom perspective view of one potential embodiment of a sawhorse device 100 of the present invention in accordance with the disclosed architecture. The bottom surface 130 of the body 110 is further comprised of at least one charging receptacle 132 and a plug 134 that provides power to the device 100. Both the charging receptacle 132 and the plug 134 are in electrical communication with at least one outlet 142 of the side wall 140 of the body 110. The outlet 142 may draw power from either the charging receptacle 132 or the plug 134 and use that power to charge or power other tools through the outlet 142. The charging receptacle 132 can receive a portable battery 190 from which it will power the device 100. The battery 190 may be charged by a battery charger 200 that can be plugged into any standard power outlet. The battery 190 may be a disposable battery or a rechargeable battery in the form of an alkaline, nickel-cadmium, nickel-metal hydride battery, etc. such as any 3-12 volt DC battery, a 36-40 volt battery or other conventional battery such as A, AA, AAA, etc. that supply power to the device 100. Throughout this specification the term “battery” 190 may be used interchangeably to refer to one or more wet or dry cells or batteries of cells in which chemical energy is converted into electricity and used as a source of DC power. References to recharging or replacing the battery 190 may refer to recharging or replacing individual cells, individual batteries of cells, or a package of multiple battery cells as is appropriate for any given battery technology that may be used.

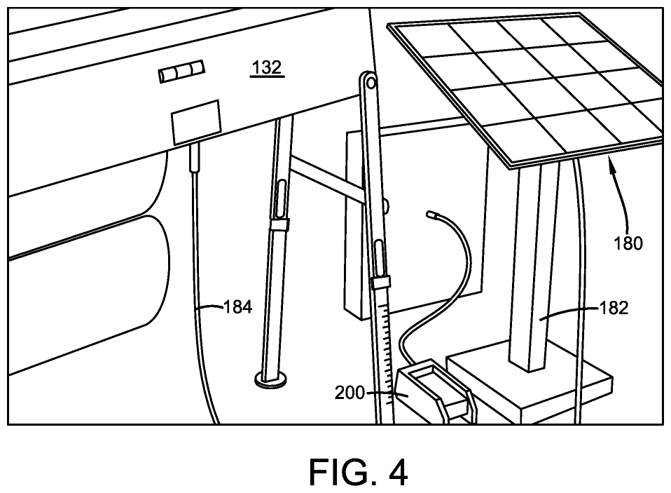

FIG. 4 illustrates a perspective view of one potential embodiment of a sawhorse device 100 of the present invention in accordance with the disclosed architecture. The plug 134 of the bottom surface 130 may receive a cord 184 that may provide power to the device 100. In one potential embodiment, the cord 184 that is received by the plug 134 may, at its other end, plug into a standard wall power outlet. In another potential embodiment, a solar panel 180 can be used to convert energy from the sun into power that can be used by the device 100. The solar panel is further comprised of at least one leg 182 to provide support and stability as well as a power cord 184 that may be plugged into the plug 134 of the bottom surface 130 of the body 110. The leg 182 of the solar panel 180, in one potential embodiment, may be able to fold or telescope into itself, allowing for field adjustments and transportability. Further, the power cord 184 of the solar panel 180 may be of any length to accommodate for positioning the device 100 at any location.

As best seen in FIG. 1, the device 100 is comprised of at least one leg 170 to support, stabilize, and level the device 100. Each leg 170 may be attached to the body 110 of the device 100 via at least one hinge 172 that allows the legs 170 to fold towards for the body 110. Once the legs 170 are folded, the device 100 may easily fit into a storage bag 210 that allows the device 100 to be easily transported and stored. The storage bag 210 may be further comprised of at least one compartment 220 to hold tools, cords, or other items that may be needed while using the device 100. Each leg 170 is further comprised of a first member 174, a second member 176, a locking handle 177, and a cross member 179. The second member 176 of the leg 170 inserts into the hollow first member 174. To adjust the length of each leg 170, the second member 176 may be pulled out of or inserted further into the first member 174 until a desired length is reached. Then, the locking handle 177 may fix the length of the leg 170 such that the device 100 is stable and secure. When on uneven ground, all legs 170 of the device 100 may be adjusted to level the device 100 for an even and flat workspace. To further stabilize the device 100, a cross member 179 may fixedly attach to the first member 174 of two separate legs 170. In addition, each leg 170 may be further comprised of a foot 178 that is textured or made of a different material, such as rubber or silicone, to provide more grip to the ground on which the device 100 is set up.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sawhorse device” and “device” are interchangeable and refer to the sawhorse device 100 of the present invention.

Notwithstanding the foregoing, the sawhorse device 100 of the present invention and its various components can be of any suitable size and configuration as is known in the art without affecting the overall concept of the invention, provided that they accomplish the above-stated objectives. One of ordinary skill in the art will appreciate that the size, configuration and material of the sawhorse device 100 as shown in the FIGS. are for illustrative purposes only, and that many other sizes and shapes of the sawhorse device 100 are well within the scope of the present disclosure. Although the dimensions of the sawhorse device 100 are important design parameters for user convenience, the sawhorse device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sawhorse device comprising:
a body;
an LED;
a power outlet;
a battery;
a charging receptable that receives the battery; and
a leg further comprised of a first member, a second member, a locking handle and a hinge.

2. The sawhorse device of claim 1 further comprising a level bubble.

3. The sawhorse device of claim 1 further comprising a hook.

4. The sawhorse device of claim 1, wherein the battery supplies power to the power outlet.

5. The sawhorse device of claim 1, wherein the leg is foldable.

6. A sawhorse device comprising:
a body;
an LED;
a power cord;
a battery;
a charging receptable that receives the battery; and
a leg further comprised of a first member, a second member, a locking handle and a hinge.

7. The sawhorse device of claim 6 further comprised of a level bubble.

8. The sawhorse device of claim 6 further comprised of a hook.

9. The sawhorse device of claim 6, wherein the power cord can extend and retract relative to the body.

10. The sawhorse device of claim 6, wherein the battery supplies power to the power cord.

11. A sawhorse device comprising:
a body comprised of a top surface having an opening;
an LED;
a power cord;
a battery;
a battery charger;
a charging receptable that receives the battery;
a leg comprised of a first member, a second member, a locking handle and a hinge; and
a storage bag.

12. The sawhorse device of claim 11 further comprised of a solar panel that supplies power to the battery.

13. The sawhorse device of claim 11, wherein the charging receptable is comprised of a charging port that receives a power cord of the solar panel.

14. The sawhorse device of claim 11, wherein the solar panel is foldable.

15. The sawhorse device of claim 11, wherein the hinge allows the leg to fold.

16. The sawhorse device of claim 15, wherein the leg is adjustable in length.

17. The sawhorse device of claim 16, wherein the leg can be locked at a length via the locking handle.

18. The sawhorse device of claim 11, wherein the LED indicates a power status of the battery.

19. The sawhorse device of claim 11 further comprised of a hook.

20. The sawhorse device of claim 11 further comprised of a level bubble.
